(19) United States
(12) Patent Application Publication
(10) Pub. No.: US 2025/0274851 A1
(43) Pub. Date: Aug. 28, 2025

(54) CHARACTERIZATION OF WIRELESS NETWORK SLICE USAGE

(71) Applicant: T-MOBILE INNOVATIONS LLC, Overland Park, KS (US)

(72) Inventors: Marouane Balmakhtar, Fairfax, VA (US); Serge M. Manning, Plano, TX (US)

(21) Appl. No.: 18/585,334

(22) Filed: Feb. 23, 2024

(51) Int. Cl. H04W 48/18; H04W 48/04; H04W 48/16

(52) U.S. Cl. CPC H04W 48/18; H04W 48/04; H04W 48/16

(57) ABSTRACT

A data communication system characterizes the use of a wireless network slice by wireless communication devices. The data communication system receives requests from the wireless communication devices to use the wireless network slice. The data communication system determines that the use of the wireless network slice by the wireless communication devices would be unauthorized, and in response, serves the wireless communication devices using the wireless network slice. The data communication system identifies a characteristic of the wireless network slice responsive to serving the wireless communication devices using the wireless network slice.

### TECHNICAL BACKGROUND

Wireless communication networks provide wireless data services to wireless communication devices like phones, computers, and other user devices. The wireless data services may include internet-access, data messaging, video conferencing, or some other data communication product. The wireless communication networks comprise wireless access nodes like Wireless Fidelity (WIFI) hotspots, Fifth Generation New Radio (5GNR) cell towers, and satellites in earth orbit. The wireless communication networks further comprise network elements the process network signaling and handle user data like Access and Mobility Management Functions, Session Management Functions (SMFs), User Plane Functions (UPFs), and Unified Data Management (UDMs).

Wireless network slices comprise network elements like UPFs and SMFs that are customized for specific user applications and network services. The wireless communication devices request the specific wireless network slice for their current user application and network service. The wireless communication networks then deliver this network service using the requested wireless network slice. For example, a wireless communication device may use a low-latency wireless network slice to serve a low-latency user application like an augmented-reality display.

There are scenarios when the use of a wireless network slice by a wireless communication device would be unauthorized. The wireless communication device may not be subscribed to the wireless network slice. The wireless communication device may be subscribed to the wireless network slice, but for some reason the wireless communication network instructs the wireless communication device not to use the slice. A request to use the wireless network slice by the wireless communication devices after receiving such an instruction would be unauthorized. The wireless communication network may instruct the wireless communication device not to request a wireless network slice when it is requesting or using another wireless network slice. Thus, the simultaneous use of both wireless network slices is not allowed. In this case, a request by the wireless communication device to use one slice when it is requesting or using the other slice would be unauthorized.

Unfortunately, the wireless communication networks fail to efficiently identify characteristics of unauthorized slice usage. Moreover, the wireless communication networks are unable to effectively identify patterns of the unauthorized slice usage across multiple wireless communication devices. These failures harm network customers by consuming network resources that could be used by legitimate users. The failures also harm the wireless communication networks through a loss of reputation and trust by their customers.

### TECHNICAL OVERVIEW

In some examples, the use of a wireless network slice by wireless communication devices is characterized. Requests from the wireless communication devices to use the wireless network slice are received. The use of the wireless network slice by the wireless communication devices is determined to be unauthorized. In response, the wireless communication devices are served using the wireless network slice. A characteristic of the wireless network slice is identified responsive to serving the wireless communication devices using the wireless network slice.

In some examples, a data communication system characterizes the use of a wireless network slice by wireless communication devices. The data communication system wirelessly broadcasts slice information related to the wireless network slice and receives requests from the wireless communication devices to use the wireless network slice. The wireless communication devices request the wireless network slice responsive to the wireless broadcast. The data communication system determines that the use of the wireless network slice by the wireless communication devices would be unauthorized, and in response, serves the wireless communication devices using the wireless network slice. The data communication system identifies a characteristic of the wireless network slice responsive to serving the wireless communication devices using the wireless network slice. The characteristic of the wireless network slice may comprise: types of the wireless communication devices, user applications in the wireless communication devices, operating systems in the wireless communication devices, destination network addresses used by the wireless communication devices, uniform resource indicators used by the wireless communication devices, and geographic locations of the wireless communication devices.

In some examples, a data communication system characterizes the use of a wireless network slice by wireless communication devices. In the data communication system, control circuitry determines that the use of the wireless network slice by the wireless communication devices would be unauthorized, and in response, directs communication circuitry to serve the wireless communication devices using the wireless network slice. The communication circuitry serves the wireless communication devices using the wireless network slice responsive to the control circuitry. The control circuitry identifies a characteristic of the wireless network slice based on the wireless communication devices use of the wireless network slice.

### DESCRIPTION OF THE DRAWINGS

FIG. 1 illustrates an exemplary data communication system to characterize use of a wireless network slice.

FIG. 2 illustrates an exemplary operation of the data communication system to characterize the use of the wireless network slice.

FIG. 3 illustrates an exemplary operation of the data communication system to characterize the use of the wireless network slice.

FIG. 4 illustrates exemplary processing circuitry to characterize use of a wireless network slice.

FIG. 5 illustrates an exemplary wireless communication network to characterize unauthorized use of a wireless network slice.

FIG. 6 illustrates an exemplary UE in the wireless communication network that characterizes the unauthorized use of the wireless network slice.

FIG. 7 illustrates an exemplary Fifth Generation New Radio (5GNR) access node in the wireless communication network that characterizes the unauthorized use of the wireless network slice.

FIG. 8 illustrates an exemplary Wireless Fidelity (WIFI) access node in the wireless communication network that characterizes the unauthorized use of the wireless network slice.

FIG. 9 illustrates an exemplary satellite access node and ground station in the wireless communication network that characterizes the unauthorized use of the wireless network slice.

FIG. 10 illustrates an exemplary Network Function Virtualization Infrastructure (NFVI) in the wireless communication network that characterizes the unauthorized use of the wireless network slice.

FIG. 11 illustrates an exemplary operation of the wireless communication network to characterize the unauthorized use of the wireless network slice.

FIG. 12 illustrates an exemplary operation of the wireless communication network to characterize the unauthorized use of the wireless network slice.

FIG. 13 illustrates an exemplary operation of the wireless communication network to characterize the unauthorized use of the wireless network slice.

### DETAILED DESCRIPTION

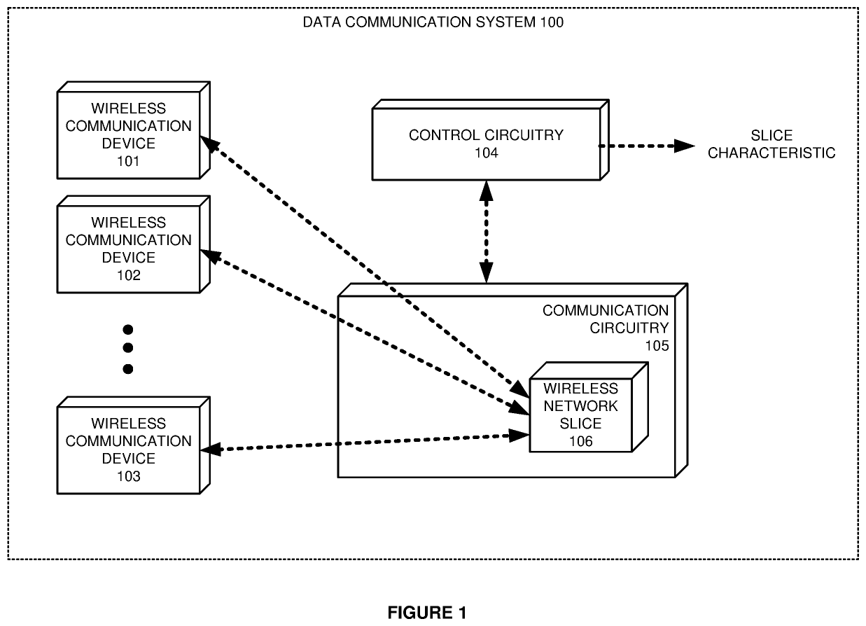

FIG. 1 illustrates exemplary data communication system 100 to characterize the use of wireless network slice 106. Data communication system 100 comprises wireless communication devices 101-103, control circuitry 104, and communication circuitry 105. Communication circuitry 105 comprises wireless network slice 106.

In some examples, wireless communication device 101 transfers a request for wireless network slice 106 to control circuitry 104 over communication circuity 105. Control circuitry 104 determines that the use of the wireless network slice 106 by wireless communication device 101 would be unauthorized. For example, wireless communication device 101 may not have a subscription to wireless network slice 106. In response to the request and lack of authorization, control circuitry 104 directs communication circuitry 105 to serve wireless communication device 101 using wireless network slice 105. Communication circuitry 105 serves wireless communication device 101 using wireless network slice 106 responsive to the direction of control circuitry 104. Control circuitry 104 identifies a characteristic of wireless network slice 106 based on the use of wireless network slice 106 by wireless communication device 101. For example, control circuitry 104 may identify a user application used by wireless communication device 101 when requesting wireless network slice 106. In some examples, wireless network slice 106 only monitors unauthorized slice usage and does not have any authorized wireless communication devices. Data communication system 100 determines additional slice characteristics or patterns of slice characteristics by serving wireless communication devices 102-103 in the manner of wireless communication device 101.

In some examples, communication circuitry 105 wirelessly broadcasts slice information related to the wireless network slice 106, and wireless communication devices 101-103 request wireless network slice 106 responsive to the wireless broadcast. The wireless broadcast may indicate that wireless network slice 106 delivers a communication service that drives wireless communication devices 101-103 to request wireless network slice 106. The communication service may comprise a high-throughput service, low-latency service, high-definition service, gaming service, telepresence service, or some other data network product. The identified characteristic of wireless network slice 106 may comprise: types of wireless communication devices 101-103, user applications in wireless communication devices 101-103, operating systems in wireless communication devices 101-103, destination network addresses used by wireless communication devices 101-103, uniform resource indicators used by wireless communication devices 101-103, geographic locations of wireless communication devices 101-103, or some other information related to the use of wireless network slice 106.

A high-throughput service transfers user data at fasts speeds for applications like software distribution. A low-latency service transfers user data with minimal delay between data blocks for applications like augmented reality. A high-definition service transfers large amounts of data per portion of media for applications like sports content streaming. A gaming service delivers interactive entertainment for applications like combat flight simulators. A telepresence service comprises video/audio distribution for applications like media conferencing. Types of wireless communication devices comprises model numbers, brand names, and the like. User applications comprise software modules that are executed in wireless user devices 101-103 and that consume slice services. Operating systems comprise software modules in wireless communication devices 101-103 that interface between user applications and device hardware. Destination network addresses are used to transfer data packets to communication end-points like web sites. Uniform resource indicators indicate end-points like web sites for data communication with wireless communication devices 101-103. Geographic locations of wireless communication devices 101-103 comprise geo-coordinates, network sectors, tracking areas, or the like.

There are various scenarios when the use of wireless network slice 106 would be unauthorized. In some scenarios, the purpose of wireless network slice 106 is to characterize unauthorized use, so slice 106 does not have any authorized devices, and any request by wireless communication devices 101-103 to use wireless network slice 106 would be unauthorized. In other scenarios, wireless communication devices 101-102 are subscribed to wireless network slice 106, but wireless communication device 103 is not subscribed to slice 106, so requests to use slice 106 by wireless communication device 103 would be unauthorized. In yet other scenarios, wireless communication devices 101-103 may be subscribed to wireless network slice 106, but for some reason data communication system 100 instructs the wireless communication devices 101-103 not to use slice 106, so requests to use wireless network slice 106 by wireless communication devices 101-103 after receiving such an instruction would be unauthorized. For example, wireless network slice 106 may not be available in the geographic area occupied by wireless communication devices 101-103. Wireless network slice 106 may not be available due to maintenance, network outage, or some other reason, and requests to use slice 106 after an instruction not to would be unauthorized. In yet another example, data communication system 100 may instruct wireless communication devices 101-103 not to request wireless network slice 106 when they are requesting or using another wireless network slice. Thus, the simultaneous use of both wireless network slices is not allowed, so a request by wireless communication devices 101-103 to use slice 106 when they are requesting or using the other slice would be unauthorized.

Wireless communication devices 101-103 comprise communication equipment that is operated by a user like phones, computers, and/or some other data communication apparatus. Control circuitry 104 comprises one or more network elements that control the delivery of wireless communication services to wireless communication devices 101-103. Control circuitry 104 may comprise an Access and Mobility Management Function (AMF), Unified Data Management (UDM), Application Server (AS), and/or some other network elements. Communication circuitry 105 comprises one or more network elements that deliver a communication service using wireless network slice 106. Communication circuitry 105 may comprise wireless access nodes, Interworking Functions (IWFs), wireless network slices, and/or some other network elements. Wireless network slice 106 comprises one or more network elements that deliver a communication service to wireless communication devices 101-103. Wireless network slice 106 comprises a Session Management Function (SMF), User Plane Function (UPF), and/or some other network elements.

Wireless communication devices 101-103 and communication circuitry 105 comprise radios that wirelessly communicate using wireless protocols like Wireless Fidelity (WIFI), Fifth Generation New Radio (5GNR), Long Term Evolution (LTE), Low-Power Wide Area Network (LP-WAN), Near-Field Communications (NFC), Code Division Multiple Access (CDMA), Frequency Division Multiple Access (FDMA), Time Division Multiple Access (TDMA), and satellite data communications. Wireless communication devices 101-103 and circuitry 104-105 comprise microprocessors, software, memories, transceivers, bus circuitry, and/or some other data processing components. The microprocessors comprise Digital Signal Processors (DSP), Central Processing Units (CPU), Graphical Processing Units (GPU), Application-Specific Integrated Circuits (ASIC), and/or some other data processing hardware. The memories comprise Random Access Memory (RAM), flash circuitry, disk drives, and/or some other type of data storage. The memories store software like operating systems, utilities, protocols, applications, and functions. The microprocessors retrieve the software from the memories and execute the software to drive the operation of data communication system 100 as described herein.

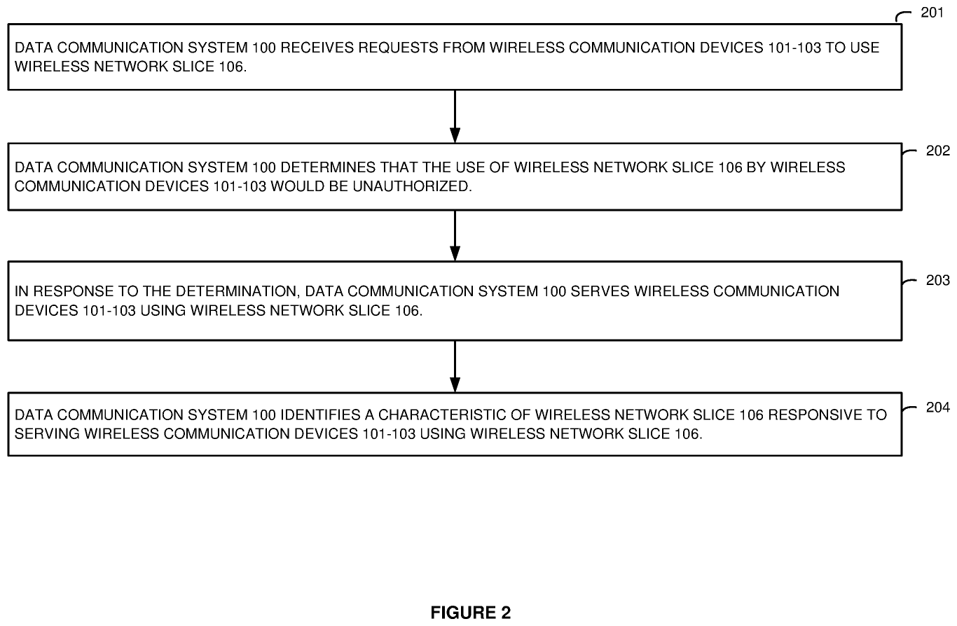

FIG. 2 illustrates an exemplary operation of data communication system 100 to characterize the use of wireless network slice 106. The operation may vary in other examples. Data communication system 100 receives requests from wireless communication devices 101-103 to use wireless network slice 106 (201). Data communication system 100 determines that the use of wireless network slice 106 by the wireless communication devices 101-103 would be unauthorized (202). In response to the determination, data communication system 100 serves wireless communication devices 101-103 using wireless network slice 106 (203). Data communication system 100 identifies a characteristic of wireless network slice 106 responsive to serving wireless communication devices 101-103 using wireless network slice 106 (204).

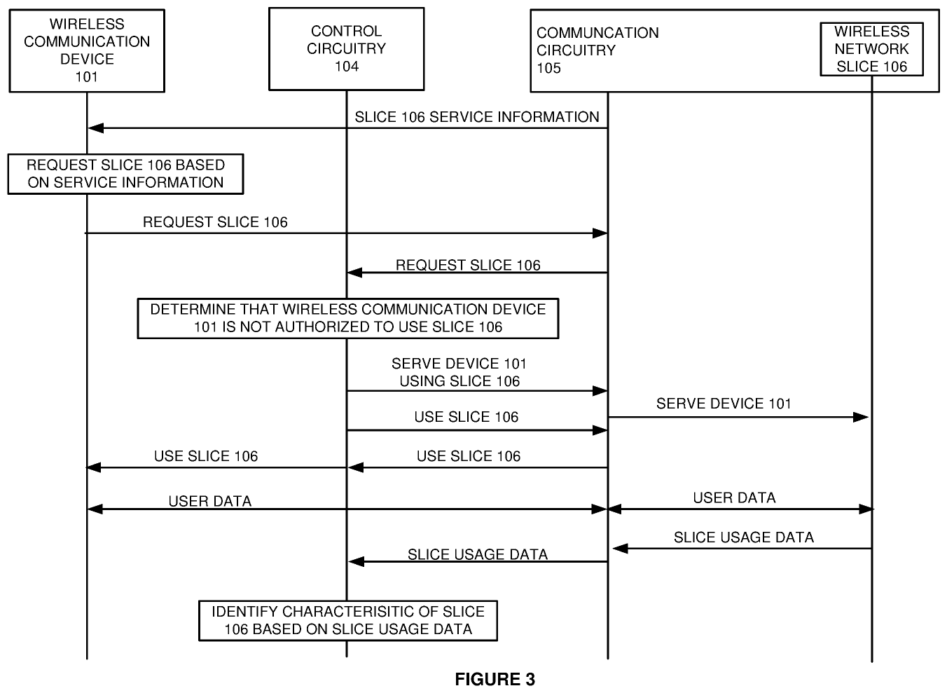

FIG. 3 illustrates an exemplary operation of data communication system 100 to characterize the unauthorized use of wireless network slice 106. The operation may vary in other examples. Communication circuitry 105 wirelessly broadcasts slice information related to wireless network slice 106. Wireless communication device 101 receives the wireless broadcast, and in response, transfers a request for wireless network slice 106 to control circuitry 104 over communication circuitry 105. The wireless broadcast may indicate that wireless network slice 106 delivers a special communication service that drives wireless communication device 101 to request wireless network slice 106.

Control circuitry 104 determines that the use of the wireless network slice 106 by wireless communication device 101 would be unauthorized. In some examples, no wireless communication devices are authorized to use wireless network slice 106. In response to the slice request and the lack of authorization, control circuitry 104 directs communication circuitry 105 to serve wireless communication device 101 using wireless network slice 106. Communication circuitry 105 directs wireless network slice 106 to serve wireless communication device 101. Over communication circuitry 105, control circuitry 104 directs wireless communication device 101 to use wireless network slice 106.

Communication circuitry 105 serves wireless communication device 101 using wireless network slice 106 responsive to the direction of control circuitry 104. Control circuitry 104 identifies a characteristic of wireless network slice 106 based on the service of wireless communication device 101 using wireless network slice 106. Additional slice characteristics or patterns of slice characteristics may be determined by serving wireless communication devices 102-103 in a similar manner.

Advantageously, data communication system 100 efficiently identifies characteristics of unauthorized slice usage. Moreover, data communication system 100 effectively identifies patterns of the unauthorized slice usage across multiple wireless communication devices. Data communication system 100 protects network resources for legitimate users. Data communication system 100 maintains a good reputation and earns the trust of their customers.

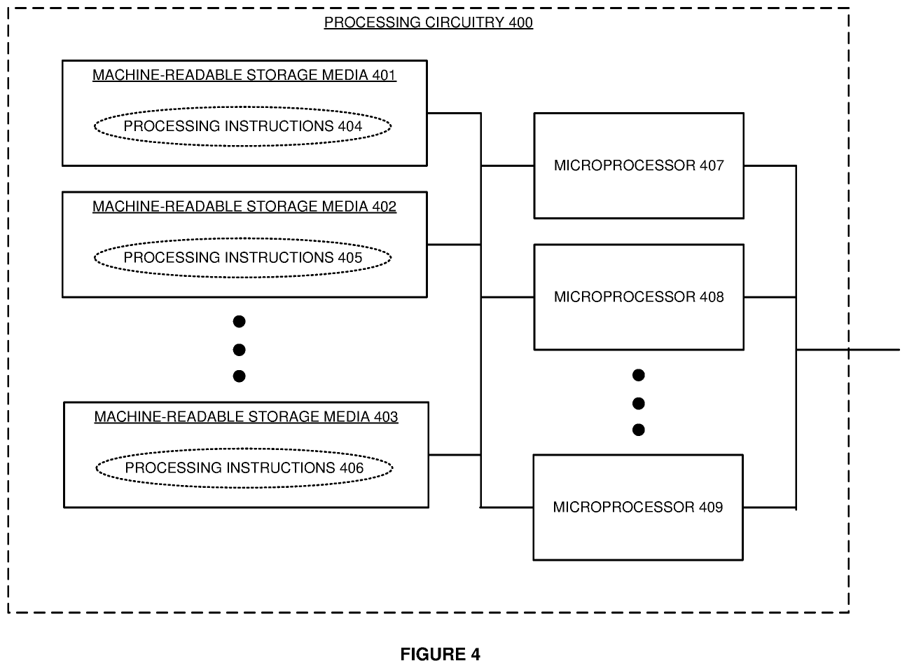

FIG. 4 illustrates exemplary processing circuitry 400 to characterize use of wireless network slices. Processing circuitry 400 comprises an example of wireless communication devices 101-103, control circuitry 104, communication circuitry 105 and network slice 106, although devices 101-103, circuitry 104-105, and slice 106 may differ. Processing circuitry 400 comprises machine-readable storage media 401-403 and microprocessors 407-409 that are communicatively coupled. Machine-readable storage media 401-403 store processing instructions 404-406 in a non-transitory manner. Microprocessors 407-409 comprise DSPs, CPUs, GPUs, ASICs, and/or some other data processing hardware. Machine-readable storage media 401-403 comprises RAM, flash circuitry, disk drives, and/or some other type of data storage apparatus. Microprocessors 407-409 retrieve processing instructions 404-406 from non-transitory machine-readable storage media 401-403. Microprocessors 407-409 execute processing instructions 404-406 to characterize the unauthorized use of wireless network slices as described above for data communication system 100 and as described below for wireless communication network 500. The amount of storage media, microprocessors, processing instructions that are shown in FIG. 4 may vary in other examples.

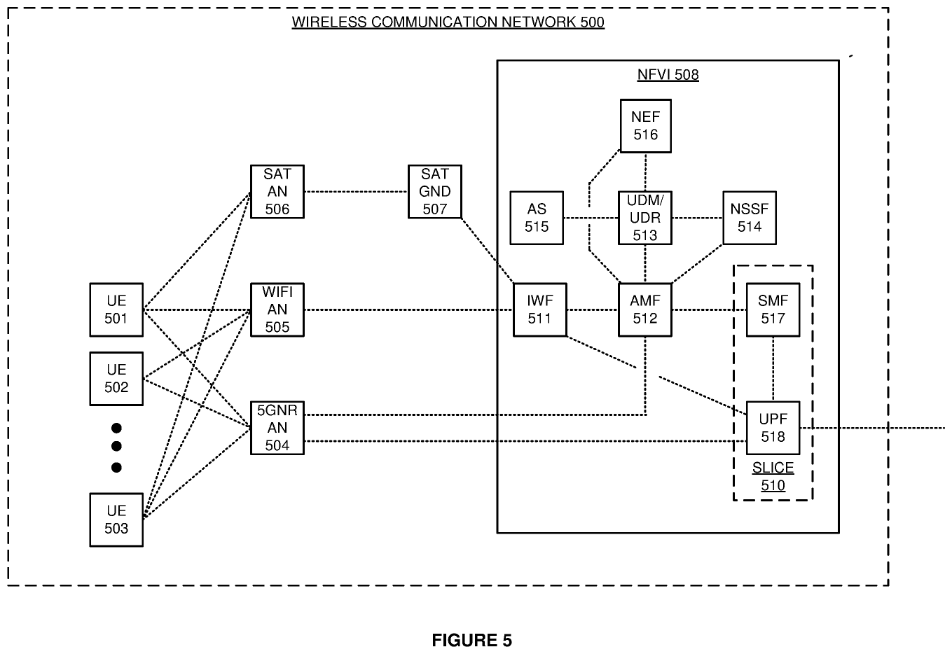

FIG. 5 illustrates exemplary wireless communication network 500 to characterize the unauthorized use of wireless network slice 510. Wireless communication network 500 comprises an example of data communication system 100 and processing circuitry 400, although system 100 and circuitry 400 may differ. Wireless communication system 500 comprises User Equipment (UE) 501-503, Fifth Generation New Radio (5GNR) Access Node (AN) 504, Wireless Fidelity (WIFI) AN 505, Satellite (SAT) AN 506, Satellite Ground Station (SAT GND) 507, and Network Function Virtualization Infrastructure (NFVI) 508. NFVI 508 comprises wireless network slice 510, Interworking Function (IWF) 511, Access and Mobility Management Function (AMF) 512, Unified Data Management and Unified Data Repository (UDM/UDR) 513, Network Slice Selection Function (NSSF) 514, Application Server (AS) 515, and Network Exposure Function (NEF) 516. Wireless network slice 510 comprises Session Management Function (SMF) 517 and User Plane Function (UPF) 518.

There are various scenarios when the use of wireless network slice 510 would be unauthorized. In some scenarios, the purpose of wireless network slice 510 is to characterize unauthorized use, so slice 510 does not have any authorized UEs, and any request by UEs 501-503 to use wireless network slice 510 would be unauthorized. In other scenarios, UEs 501-502 are subscribed to wireless network slice 510, but UE 503 is not subscribed to slice 510, so requests to use slice 510 by UE 503 would be unauthorized. In yet other scenarios, UEs 501-503 may be subscribed to wireless network slice 510, but for some reason wireless communication network 510 instructs the UEs 501-503 not to use slice 510, so requests to use wireless network slice 510 by UEs 501-503 after receiving such an instruction would be unauthorized. For example, wireless network slice 510 may not be available in the geographic area occupied by UEs 501-503. Wireless network slice 510 may not be available due to maintenance, network outage, or some other reason, and requests to use slice 510 after such an instruction would be unauthorized. In yet another example, wireless communication network 500 may instruct UEs 501-503 not to request wireless network slice 510 when they are requesting or using another wireless network slice. Thus, the simultaneous use of both wireless network slices is not allowed, so a request by UEs 501-503 to use slice 510 when they are requesting or using the other slice would be unauthorized.

5GNR AN 504 wirelessly broadcasts System Information Blocks (SIBs) that describe wireless network slice 510 by slice type, slice differentiator, and possibly other information. AMF 512 may also transfer slice type, slice differentiator, and other slice information to UEs 501-503 over Non-Access Stratum (NAS) messages that traverse one of the following paths: 1) 5GNR 504, 2) IWF 511 and WIFI AN 505, and 3, IWF 511, SAT GND 507, and SAT AN 506.

In operation, UE 501 transfers a request to AMF 512 over 5GNR AN 505 to use wireless network slice 510 in response to the SIBs and/or NAS messages. AMF 512 interacts with UDM/UDR 513 to determine if the request for slice 510 by UE 501 is authorized. In this example, UE 501 is not authorized because it is not subscribed to slice 510. Based on rules for slice 510 in UDM/UDR 513, UDM/UDR 513 directs AMF 513 to establish a data session for UE 501 to use slice 510 and collect slice usage data. Alternatively, AMF 512 may interact with NSSF 514 based on UDM/UDR data for UE 501 to determine that UE 501 is not authorized and to implement a data session to collect session data to characterize the unauthorized slice usage.

AMF 512 interacts with UDM/UDR 513, SMF 517, and typically other network functions to develop UE context for the data session like network addressing and quality-of-service levels. AMF 512 transfers the UE context to SMF 517 which forwards some UE context to UPF 518. AMF 512 transfers the UE context to 5GNR AN 504. AMF 512 also transfers some UE context to UE 501 over 5GNR AN 504. AMF 512 may interact with UE 501 over NAS messaging that traverses 5GNR AN 505 to collect session information like the device model, operating system version, and user application that are related to the use of slice 510.

UE 501 and UPF 518 exchange user data over 5GNR AN 504 per the UE context. UPF may exchange the user data with external data systems like web sites. UPF 518 analyzes the user data for session information like traffic types, destination network addresses, uniform resource indicators, and the like. AMF 512 collects session information from 5GNR AN 504 like geographic locations of UE 501, UE mobility, radio status, and the like. AMF 512 also collects the session information from the UE context and UDM/UDR data for UE 501. UE 501, 5GNR 504, UDM/UDR 513, SMF 517, and UPF 518 transfer their session information to AMF 512. AMF 512 transfers the session information to UDM/UDR 513.

After collecting the session information related to the use of wireless network slice 510 by UE 501, AMF 512 signals 5GNR AN 504, SMF 517, and possibly UE 501 to terminate the data session. SMF 517 directs UPF 518 to terminate the data session. 5GNR AN 504 and UPF 518 stop the exchange of the user data between UE 501 and wireless network slice 510.

AS 515 retrieves the session information for UE 501 from UDM/UDR 513. AS 515 processes the session data to determine characteristics for the use of slice 510 like UE location, UE operating system, UE user application, UE radio status, quality-of-service, network addresses, uniform resource indicators, traffic types, and the like. Subsequently, AS 515 aggregates the characteristics with those developed for UEs 502-503 to detect patterns of slice usage.

In another operation, slice 510 is not available in the tracking area occupied by UE 502, so AMF 512 instructs UE 502 not to request slice 510. Against this instruction, UE 502 still transfers a request to AMF 512 over WIFI AN 505 and IWF 511 to use wireless network slice 510—possibly in response to SIBs and/or NAS messages. AMF 512 interacts with UDM/UDR 513 to determine that the request for slice 510 by UE 502 is not authorized. Based on rules for slice 510 in UDM/UDR 513, UDM/UDR 513 directs AMF 513 to establish a data session for UE 502 to use slice 510 and collect slice usage data. Alternatively, AMF 512 may interact with NSSF 514 based on UDM/UDR data for UE 502 to determine that UE 502 is not authorized and to implement a data session to collect session data to characterize the unauthorized slice usage.

AMF 512 interacts with UDM/UDR 513, SMF 517, and typically other network functions to develop UE context for the data session like network addressing and quality-of-service levels. AMF 512 transfers the UE context to SMF 517 which forwards some UE context to UPF 518. AMF 512 transfers the UE context to IWF 511. AMF 512 also transfers some UE context to UE 502 over IWF 511 and WIFI AN 505. AMF 512 may interact with UE 501 over NAS messaging that traverses IWF 511 and WIFI AN 505 to collect session information like the device model, operating system version, and user application that are related to the use of slice 510.

UE 502 and UPF 518 exchange user data over WIFI AN 505 and IWF 511 per the UE context. UPF 518 may exchange the user data with external data systems like web sites. UPF 518 analyzes the user data for session information like traffic types, destination network addresses, uniform resource indicators, and the like. AMF 512 collects session information from the UE context and UDM/UDR data for UE 502. UE 502, UDM/UDR 513, SMF 517, and UPF 518 transfer their session information to AMF 512. AMF 512 transfers the session information to UDM/UDR 513.

After collecting the session information for the use of wireless network slice 510 by UE 502, AMF 512 signals IWF 511, SMF 517, and possibly UE 502 to terminate the data session. SMF 517 directs UPF 518 to terminate the data session. IWF 511 and UPF 518 stop the exchange of the user data between UE 502 and wireless network slice 510.

AS 515 retrieves the session information for UE 502 from UDM/UDR 513. AS 515 processes the session data to determine characteristics for the use of slice 510 by UE 502 like UE location, UE operating system, UE user application, UE quality-of-service, network addresses, uniform resource indicators, traffic types, and the like. Subsequently, AS 515 aggregates the characteristics with those developed for UEs 501 and 503 to detect patterns of slice usage.

In another operation, AMF 512 instructs UE 503 not to request slice 510 when using a different satellite-based slice. UE 503 is using the satellite based slice and against the instruction, UE 503 still transfers a request to AMF 512 over SAT AN 506, SAT GND 507, and IWF 511 to use wireless network slice 510—possibly in response to SIBs and/or NAS messages. AMF 512 interacts with UDM/UDR 513 to determine that the request for slice 510 by UE 503 is not authorized. Based on rules for slice 510 in UDM/UDR 513, UDM/UDR 513 directs AMF 513 to establish a data session for UE 503 to use slice 510 and collect slice usage data. Alternatively, AMF 512 may interact with NSSF 514 based on UDM/UDR data for UE 503 to determine that UE 503 is not authorized and to implement a data session to collect session data to characterize the unauthorized slice usage.

AMF 512 interacts with UDM/UDR 513, SMF 517, and typically other network functions to develop UE context for the data session like network addressing and quality-of-service levels. AMF 512 transfers the UE context to SMF 517 which forwards some UE context to UPF 518. AMF 512 transfers the UE context to IWF 511. AMF 512 also transfers some UE context to UE 503 over IWF 511, SAT GND 507, and SAT AN 506. AMF 512 may interact with UE 503 over NAS messaging that traverses IWF 511, SAT GND 507, and SAT AN 506 to collect session information like the device model, operating system version, and user application that are related to the use of slice 510.

UE 501 and UPF 518 exchange user data over SAT AN 506, SAT GND 507, and IWF 511 per the UE context. UPF 518 may exchange the user data with external data systems like web sites. UPF 518 analyzes the user data for session information like traffic types, destination network addresses, uniform resource indicators, and the like. AMF 512 collects session information from the UE context and UDM/UDR data for UE 503. UE 502, UDM/UDR 513, SMF 517, and UPF 518 transfer their session information to AMF 512. AMF 512 transfers the session information to UDM/UDR 513.

After collecting the session information for the use of wireless network slice 510 by UE 503, AMF 512 signals IWF 511, SMF 517, and possibly UE 501 to terminate the data session. SMF 517 directs UPF 518 to terminate the data session. IWF 511 and UPF 518 stop the exchange of the user data between UE 503 and wireless network slice 510.

AS 515 retrieves the session information for UE 503 from UDM/UDR 513. AS 515 processes the session data to determine characteristics for the use of slice 510 by UE 503 like UE location, UE operating system, UE user application, UE quality-of-service, network addresses, uniform resource indicators, traffic types, and the like. Subsequently, AS 515 aggregates the characteristics with those developed for UEs 501-502 to detect patterns of slice usage. For example, AS 515 may detect a common user application and operating system version in UEs 501-503 when they use slice 510 in an unauthorized manner. In another example, AS 515 may detect a common geographic location and device type for UEs 501-503 when they use slice 510 in an unauthorized manner.

In another operation, NEF 516 stores rules for slice 510 and UEs 501-503. UE 503 transfers a request to AMF 512 over SAT AN 506, SAT GND 507, and IWF 511 to use wireless network slice 510—possibly in response to SIBs and/or NAS messages. AMF 512 interacts with NEF 516 to determine that the request for slice 510 by UE 503 is not authorized. Based on rules for slice 510 and UE 503, NEF 516 directs AMF 513 to establish a data session for UE 503 to use slice 510 and collect slice usage data. AMF 512 interacts with UDM/UDR 513, SMF 517, and typically other network functions to develop UE context for the data session like network addressing and quality-of-service levels. AMF 512 transfers the UE context to SMF 517 which forwards some UE context to UPF 518. AMF 512 transfers the UE context to IWF 511. AMF 512 also transfers some UE context to UE 503 over IWF 511, SAT GND 507, and SAT AN 506. AMF 512 may interact with UE 503 over NAS messaging that traverses IWF 511, SAT GND 507, and SAT AN 506 to collect session information like the device model, operating system version, and user application that are related to the use of slice 510.

UE 501 and UPF 518 exchange user data over SAT AN 506, SAT GND 507, and IWF 511 per the UE context. UPF 518 may exchange the user data with external data systems like web sites. UPF 518 analyzes the user data for session information like traffic types, destination network addresses, uniform resource indicators, and the like. AMF 512 collects session information from the UE context and UDM/UDR data for UE 503. UE 502, UDM/UDR 513, SMF 517, and UPF 518 transfer their session information to AMF 512. AMF 512 transfers the session information to UDM/UDR 513.

After collecting the session information for the use of wireless network slice 510 by UE 503, AMF 512 signals IWF 511, SMF 517, and possibly UE 501 to terminate the data session. SMF 517 directs UPF 518 to terminate the data session. IWF 511 and UPF 518 stop the exchange of the user data between UE 503 and wireless network slice 510.

NEF 516 retrieves the session information for UE 503 from UDM/UDR 513. NEF 516 processes the session data to determine characteristics for the use of slice 510 by UE 503 like UE location, UE operating system, UE user application, UE quality-of-service, network addresses, uniform resource indicators, traffic types, and the like. Subsequently, NEF 516 aggregates the characteristics with those developed for UEs 501-502 to detect patterns of slice usage. For example, NEF 516 may detect a common user application and geographic location for UEs 501-503 when they use slice 510 in an unauthorized manner.

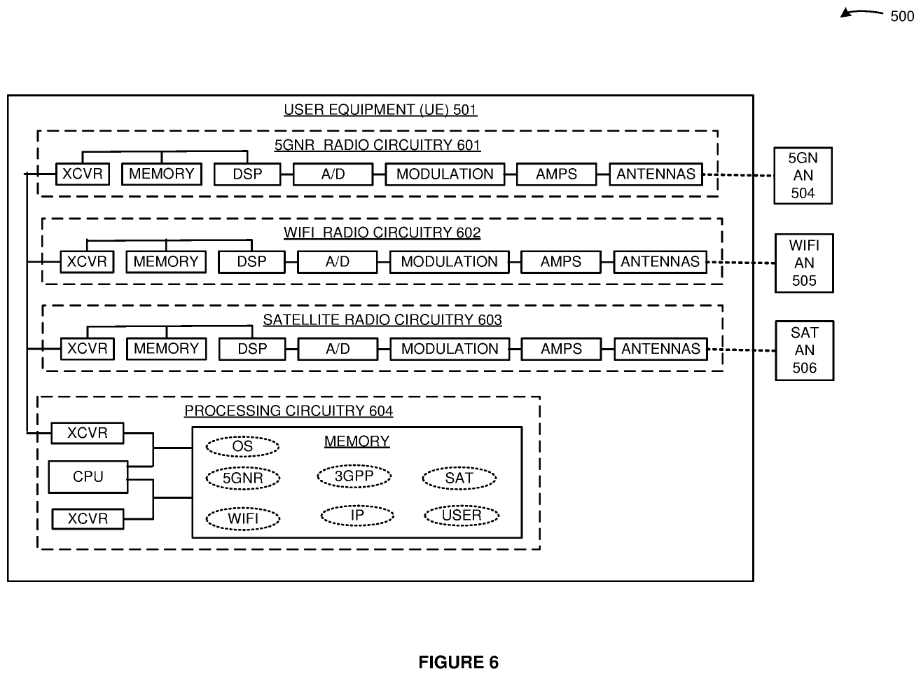

FIG. 6 illustrates exemplary UE 501 in wireless communication network 500 that characterizes the unauthorized use of wireless network slice 510. UE 501 comprises an example of wireless communication devices 101-103 and UEs 502-503, although devices 101-103 and UEs 502-503 may differ. UE 501 comprises Fifth Generation New Radio (5GNR) radio circuitry 601, Wireless Fidelity (WIFI) radio circuitry 602, satellite radio circuitry 603, and processing circuitry 604. Radio circuitry 601-603 comprises antennas, amplifiers, filters, modulation, analog-to-digital interfaces, DSPs, memories, and transceivers (XCVRs) that are coupled over bus circuitry. Processing circuitry 604 comprises one or more CPUs, one or more memories, and one or more transceivers that are coupled over bus circuitry. The one or more memories in processing circuitry 604 store software like an Operating System (OS), 5GNR Application (5GNR), 3GPP Application (3GPP), WIFI Application (WIFI), Satellite Application (SAT), and Internet Protocol application (IP). The antennas in radio circuitry 601-603 exchange wireless signals with ANs 504-506. Transceivers in radio circuitry 601-603 are coupled to transceivers in processing circuitry 604. In processing circuitry 604, the one or more CPUs retrieve the software from the one or more memories and execute the software to direct the operation of UE 501 as described herein.

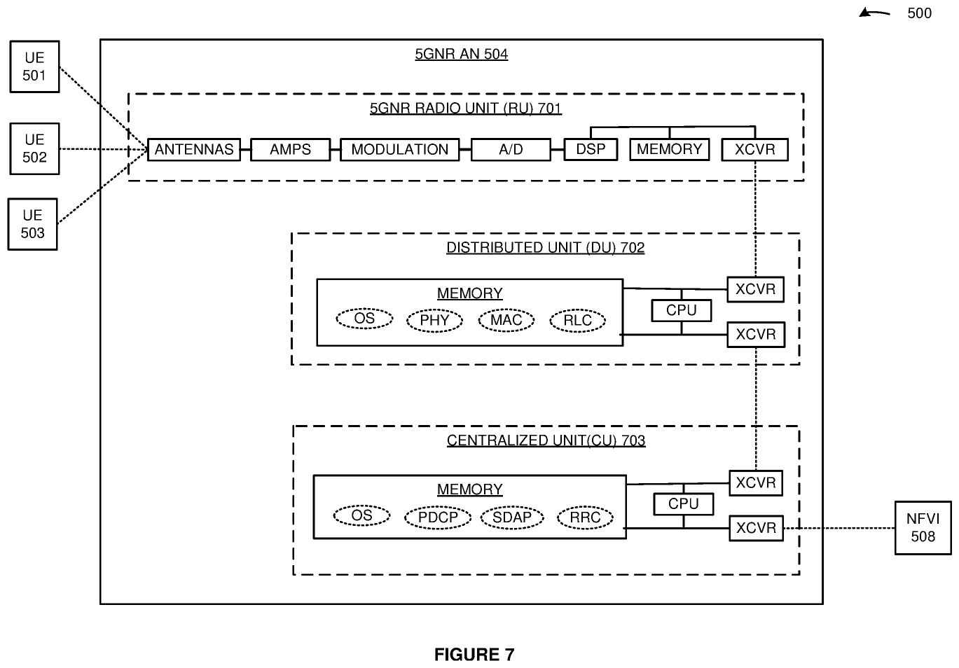

FIG. 7 illustrates exemplary Fifth Generation New Radio (5GNR) Access Node (AN) 504 in wireless communication network 500 that characterizes the unauthorized use of wireless network slice 510. 5GNR AN 504 comprises an example of communication circuitry 105 and processing circuitry 400, although circuitry 105 and circuitry 400 may differ. 5GNR AN 504 comprises 5GNR Radio Unit (RU) 701, Distributed Unit (DU) 702, and Centralized Unit (CU) 703. 5GNR RU 701 comprises antennas, amplifiers, filters, modulation, analog-to-digital interfaces, DSP, memory, radio applications, and transceivers that are coupled over bus circuitry. DU 702 comprises memory, CPU, user interfaces and components, and transceivers that are coupled over bus circuitry. The memory in DU 702 stores operating system and 5GNR network applications for Physical Layer (PHY), Media Access Control (MAC), and Radio Link Control (RLC). CU 703 comprises memory, CPU, and transceivers that are coupled over bus circuitry. The memory in CU 703 stores an operating system and 5GNR network applications for Packet Data Convergence Protocol (PDCP), Service Data Adaption Protocol (SDAP), and Radio Resource Control (RRC). The antennas in 5GNR RU 701 are wirelessly coupled to UEs 501-503 over 5GNR links. Transceivers in 5GNR RU 701 are coupled to transceivers in DU 702. Transceivers in DU 702 are coupled to transceivers in CU 703. Transceivers in CU 703 are coupled to transceivers in NFVI 508. The DSP and CPU in RU 701, DU 702, and CU 703 execute the radio applications, operating systems, and network applications to exchange data and signaling between UEs 501-503 and NFVI 508 as described herein.

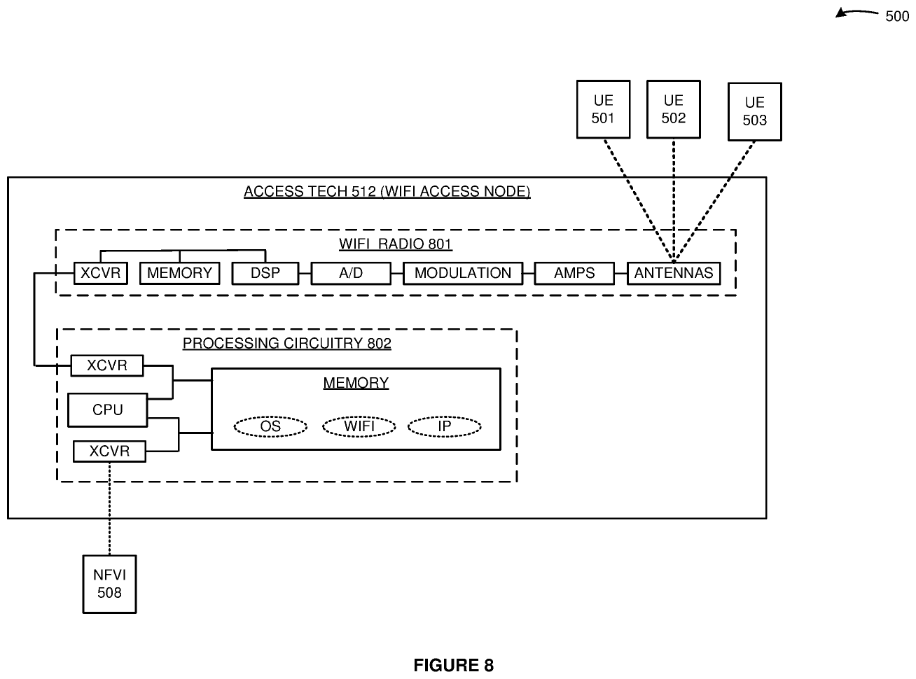

FIG. 8 illustrates exemplary Wireless Fidelity (WIFI) AN 505 in wireless communication network 500 that characterizes the unauthorized use of wireless network slice 510. WIFI AN 505 comprises an example of communication circuitry 105 and processing circuitry 400, although circuitry 105 and circuitry 400 may differ. WIFI AN 505 comprises WIFI radio 801 and processing circuitry 802. Radio 801 comprises antennas, amplifiers, filters, modulation, analog-to-digital interfaces, DSPs, memories, and transceivers that are coupled over bus circuitry. Processing circuitry 802 comprises one or more CPUs, one or more memories, and one or more transceivers that are coupled over bus circuitry. The one or more memories in processing circuitry 802 store software like an Operating System (OS), WIFI application (WIFI), and IP application (IP). The antennas in WIFI radio 801 exchange WIFI signals with UEs 501-503. Transceivers in radio 801 are coupled to transceivers in processing circuitry 802. Transceivers in processing circuitry 802 are coupled to transceivers in NFVI 508. In processing circuitry 802, the one or more CPUs retrieve the software from the one or more memories and execute the software to exchange data and signaling between UEs 501-503 and NFVI 508 as described herein.

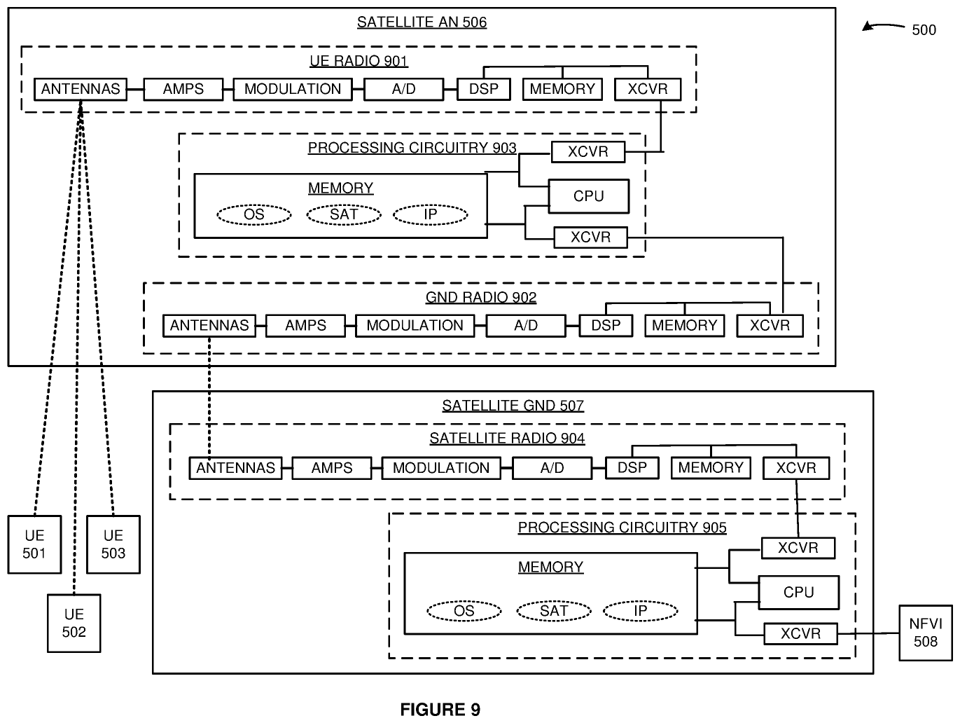

FIG. 9 illustrates exemplary SAT AN 506 and SAT GND 507 in wireless communication network 500 that characterizes the unauthorized use of wireless network slice 510. SAT AN 506 and SAT GND 507 comprise examples of communication circuitry 105 and processing circuitry 400, although circuitry 105 and circuitry 400 may differ. SAT AN 506 comprises UE radio 901, GND radio 902 and processing circuitry 903. SAT GND 507 comprises satellite radio 904 and processing circuitry 905. Radios 901-902 and 904 comprise antennas, amplifiers, filters, modulation, analog-to-digital interfaces, DSPs, memories, and transceivers that are coupled over bus circuitry. Processing circuitry 903 and 905 comprise one or more CPUs, one or more memories, and one or more transceivers that are coupled over bus circuitry. The one or more memories in processing circuitry 903 and 905 store software like an Operating System (OS), Satellite Application (SAT), and IP Application (IP). The antennas in UE radio 901 exchange satellite signals with UEs 501-503. Transceivers in UE radio 901 are coupled to transceivers in processing circuitry 903. Transceivers in processing circuitry 903 are coupled to transceivers in GND radio 902. The antennas in GND radio 902 exchange satellite signals with antennas in satellite radio 904, and the antennas in satellite radio 904 exchange the satellite signals with GND radio 902. Transceivers in satellite radio 904 are coupled to transceivers in processing circuitry 905. Transceivers in processing circuitry 905 are coupled to transceivers in NFVI 508. In processing circuitry 903 and 905, the one or more CPUs retrieve the software from the one or more memories and execute the software to exchange data and signaling between UEs 501-503 and NFVI 508 as described herein.

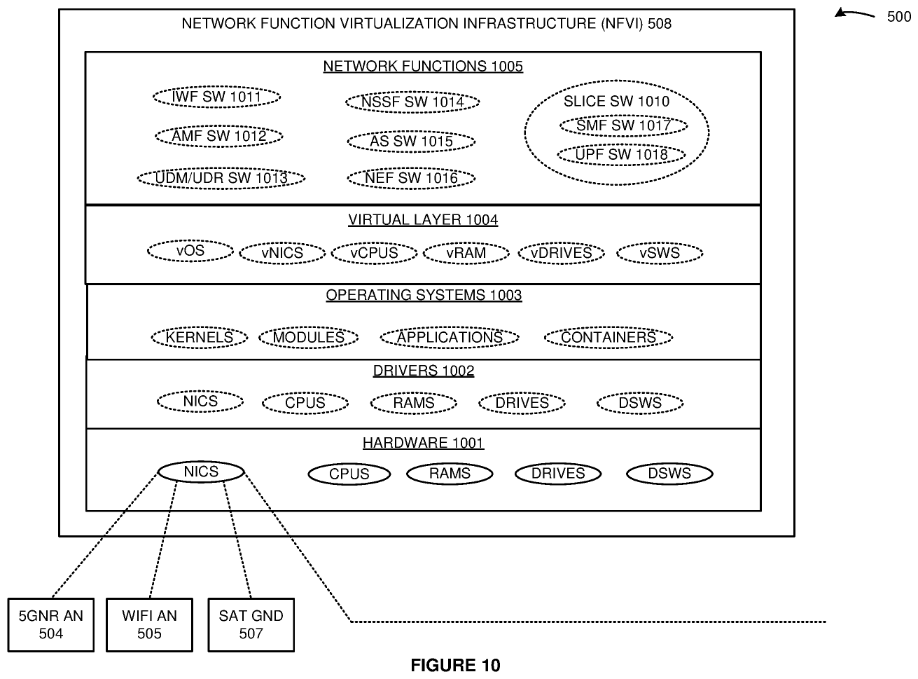

FIG. 10 illustrates exemplary Network Function Virtualization Infrastructure (NFVI) 508 in wireless communication network 500 that characterizes the unauthorized use of wireless network slice 510. NFVI 508 comprises an example of control circuitry 104, communication circuitry 105, and processing circuitry 400, although circuitry 104-105 and circuitry 400 may differ. NFVI 508 comprises hardware 1001, hardware drivers 1002, operating systems 1003, virtual layer 1004, and network functions 1005. Hardware 1001 comprises Network Interface Cards (NICS), CPUS, RAM, Flash/Disk Drives (DRIVES), and Data Switches (DSWS). Hardware drivers 1002 comprise software that is resident in the NICS, CPUS, RAM, DRIVES, and DSWS. Operating systems 1003 comprise kernels, modules, applications, and containers. Virtual layer 1004 comprises virtual Operating Systems (vOS), vNICS, vCPUS, vRAM, vDRIVES, and vSWS. Network Functions 1005 comprises Slice SW 1010, IWF SW 1011, AMF SW 1012, UDM/UDR SW 1013, NSSF SW 1014, AS SW 1015, and NEF SW 1016. Slice SW 1010 comprises SMF SW 1017 and UPF SW 1018. The NICS in hardware 1001 are coupled to ANs 504-505, SAT GND 507, and external systems. Hardware 1001 executes hardware drivers 1002, operating systems 1003, virtual layer 1004, and network functions 1005 to form and operate IWF 511, AMF 512, UDM/UDR 513, NSSF 514, AS 515, NEF 516, SMF 517, and UPF 518 as described herein. NFVI 508 comprises one or more microprocessors and one or more non-transitory machine-readable storage media that store processing instructions that direct NFVI 508 to exchange data and signaling between ANs 504-505, SAT GND 507, and external systems as described herein. NFVI 508 may be located at a single site or be distributed across multiple geographic locations.

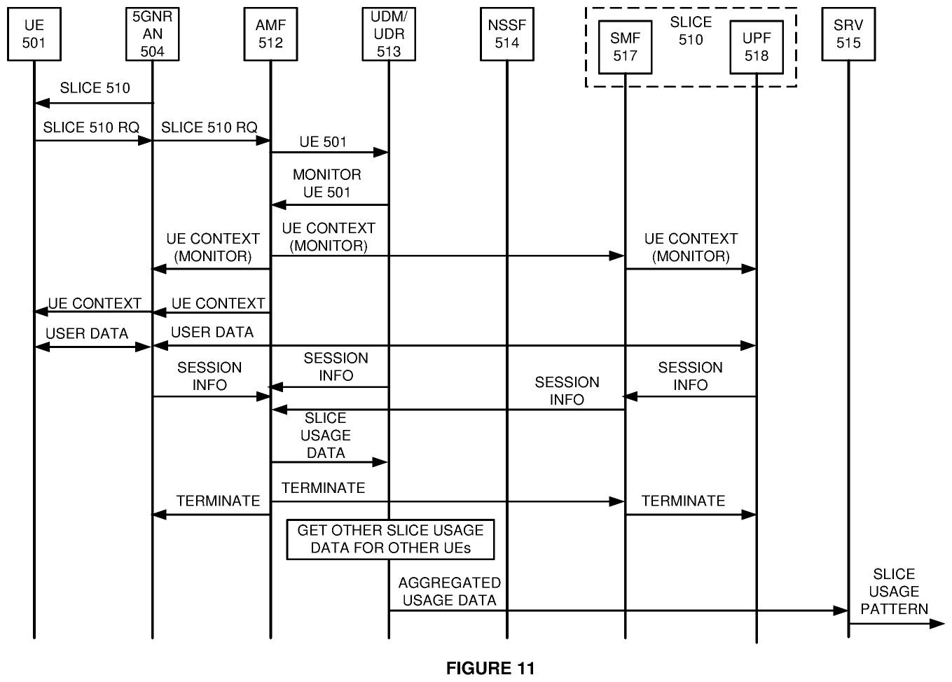

FIG. 11 illustrates an exemplary operation of wireless communication network 500 to characterize the unauthorized use of wireless network slice 510. The operation may differ in other examples. 5GNR AN 504 wirelessly broadcasts information related to slice 510 like slice type and differentiator. UE 501 receives the broadcast slice information, and in response, transfers a request (RQ) for slice 510 to AMF 512 over 5GNR AN 504. AMF 512 retrieves UE information for UE 501 from UMD/UDR 513. The UE information indicates that AMF 512 should monitor UE 501 when it attempts to use slice 510. AMF 512 develops UE context for UE 501 to use slice 510 like network addressing and quality-of-service levels. AMF 512 transfers the UE context with instructions to monitor and report on UE 501 to SMF 517 and 5GNR AN 504. SMF 517 transfers the UE context with instructions to monitor and report on UE 501 to UPF 518. AMF 512 transfers the UE context to UE 501 over 5GNR AN 504. In response to the UE context, UE 501 exchanges user data with UPF 518 over 5GNR AN 504.

UE 501, 5GNR AN 504, UDM/UDR 513, SMF 517, and UPF 518 generate session information related to the use of slice 510 by UE 501 and transfer the session information to AMF 512. The session information indicates the user application and operating system version being used by UE 501 to use slice 510. The session information indicates the network addresses and uniform resource indicator being used by UE 501 to use slice 510. The session information indicates the quality-of-service levels and geographic locations being used by UE 501 to use slice 510. AMF 512 processes the session information to generate slice usage data for UE 501 and slice 510. AMF transfers the slice usage data to UDM/UDR 513. AMF 512 signals 5GNR AN 504 and SMF 517 to terminate the data session between UE 501 and slice 510. SMF 517 signals UPF 518 to terminate the data session between UE 501 and slice 510. 5GNR AN 504 and UPF 518 stop the exchange of user data between UE 501 and slice 510.

Although not shown, UEs 502-503 are handled in the same manner and their slice usage information is also transferred to UDM/UDR 513 by AMF 512. UDM/UDR 513 aggregates this slice usage data for UEs 501-503 and transfers the aggregated slice usage data to AS 515. AS 515 processes the slice usage data for slice 510 to determine characteristics and patterns related to the slice usage. For example, AS 515 may detect a common operating system version that uses slice 510 in an unauthorized manner.

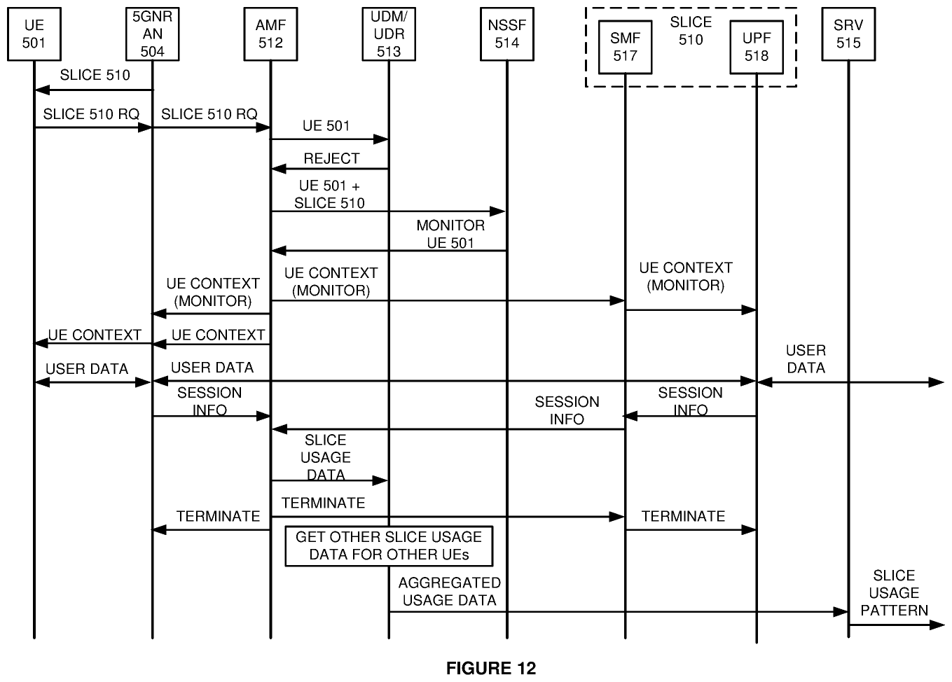

FIG. 12 illustrates an exemplary operation of wireless communication network 500 to characterize the unauthorized use of wireless network slice 510. The operation may differ in other examples. 5GNR AN 504 wirelessly broadcasts information related to slice 510 like slice type and differentiator. UE 501 receives the broadcast slice information, and in response, transfers a request for slice 510 to AMF 512 over 5GNR AN 504. AMF 512 retrieves UE information for UE 501 from UMD/UDR 513. The UE information indicates that the request from UE 501 to use slice 510 is rejected. AMF 512 queries NSSF 514 for slice selection assistance for UE 501 and slice 510. NSSF 514 responds to AMF 512 that UE 501 is not authorized to use slice 510 but that AMF 512 should monitor UE 501 when it uses slice 510.

AMF 512 develops UE context for UE 501 to use slice 510 like network addressing and quality-of-service levels. AMF 512 transfers the UE context with instructions to monitor and report on UE 501 to SMF 517 and 5GNR AN 504. SMF 517 transfers the UE context with instructions to monitor and report on UE 501 to UPF 518. AMF 512 transfers the UE context to UE 501 over 5GNR AN 504. In response to the UE context, UE 501 exchanges user data with UPF 518 over 5GNR AN 504.

UE 501, 5GNR AN 504, UDM/UDR 513, SMF 517, and UPF 518 generate session information related to the use of slice 510 by UE 501 and transfer the session information to AMF 512. The session information indicates the user application and operating system version being used by UE 501 to use slice 510. The session information indicates the network addresses and uniform resource indicator being used by UE 501 to use slice 510. The session information indicates the quality-of-service levels and geographic locations being used by UE 501 to use slice 510. AMF 512 processes the session information to generate slice usage data for UE 501 and slice 510. AMF transfers the slice usage data to UDM/UDR 513. AMF 512 signals 5GNR AN 504, and SMF 517 to terminate the data session between UE 501 and slice 510. SMF 517 signals UPF 518 to terminate the data session between UE 501 and slice 510. 5GNR AN 504 and UPF 518 stop the exchange of user data between UE 501 and slice 510.

Although not shown, UEs 502-503 are handled in the same manner and their slice usage information is also transferred to UDM/UDR 513 by AMF 512. UDM/UDR 513 aggregates this slice usage data for multiple UEs and transfers the aggregated slice usage data to AS 515. AS 515 processes the slice usage data for slice 510 to determine characteristics and patterns related to the slice usage. For example, AS 515 may detect a common user application that uses slice 510 in an unauthorized manner.

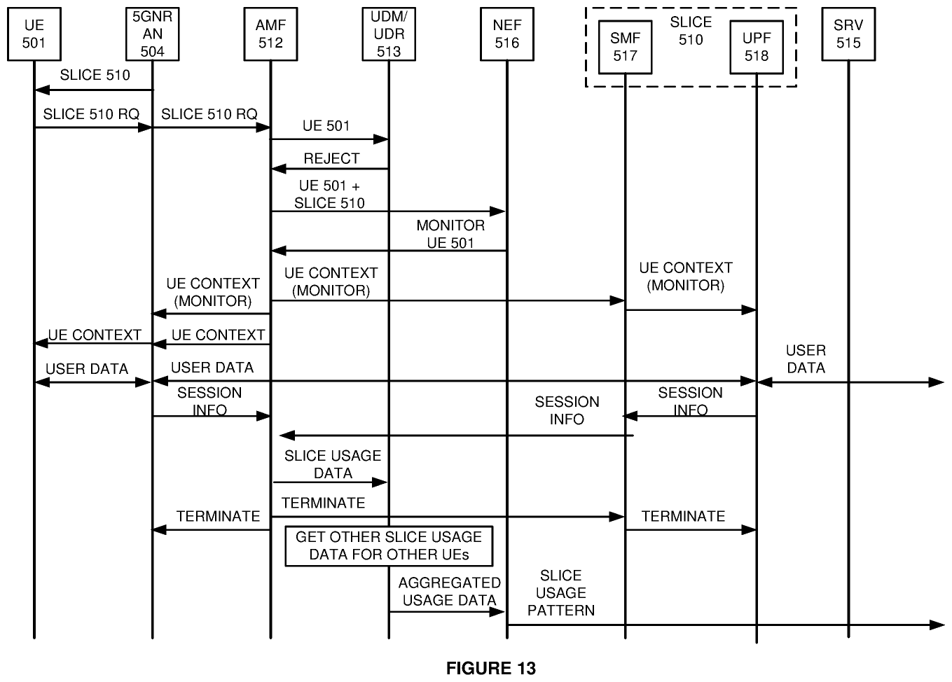

FIG. 13 illustrates an exemplary operation of wireless communication network 500 to characterize the unauthorized use of wireless network slice 510. The operation may differ in other examples. 5GNR AN 504 wirelessly broadcasts information related to slice 510 like slice type and differentiator. UE 501 receives the broadcast slice information, and in response, transfers a request for slice 510 to AMF 512 over 5GNR AN 504. AMF 512 retrieves UE information for UE 501 from UMD/UDR 513. The UE information indicates that the request from UE 501 to use slice 510 is rejected. AMF 512 queries NEF 514 for slice control assistance for UE 501 and slice 510. NEF 514 applies user permissions, network policies, and resource availability to determine that UE 501 should not be authorized to use slice 510 but that AMF 512 should monitor UE 501 when it uses slice 510.

AMF 512 develops UE context for UE 501 to use slice 510 like network addressing and quality-of-service levels. AMF 512 transfers the UE context with instructions to monitor and report on UE 501 to SMF 517 and 5GNR AN 504. SMF 517 transfers the UE context with instructions to monitor and report on UE 501 to UPF 518. AMF 512 transfers the UE context to UE 501 over 5GNR AN 504. In response to the UE context, UE 501 exchanges user data with UPF 518 over 5GNR AN 504.

UE 501, 5GNR AN 504, UDM/UDR 513, SMF 517, and UPF 518 generate session information related to the use of slice 510 by UE 501 and transfer the session information to AMF 512. The session information indicates the user application and operating system version being used by UE 501 to use slice 510. The session information indicates the network addresses and uniform resource indicator being used by UE 501 to use slice 510. The session information indicates the quality-of-service levels and geographic locations being used by UE 501 to use slice 510. AMF 512 processes the session information to generate slice usage data for UE 501 and slice 510. AMF transfers the slice usage data to NEF 516. AMF 512 signals 5GNR AN 504, and SMF 517 to terminate the data session between UE 501 and slice 510. SMF 517 signals UPF 518 to terminate the data session between UE 501 and slice 510. 5GNR AN 504 and UPF 518 stop the exchange of user data between UE 501 and slice 510.

Although not shown, UEs 502-503 are handled in the same manner and their slice usage information is also transferred to UDM/UDR 513 by AMF 512. UDM/UDR 513 aggregates this slice usage data for multiple UEs and transfers the aggregated slice usage data to NEF 516. NEF 516 processes the slice usage data for slice 510 to determine characteristics and patterns related to the slice usage. For example, NEF 156 may detect a common user application that uses slice 510 in an unauthorized manner.

Advantageously, wireless communication network 500 efficiently identifies characteristics of unauthorized slice usage. Moreover, wireless communication network 500 effectively identifies patterns of the unauthorized slice usage across multiple UEs. Wireless communication network 500 protects network resources for legitimate users. Wireless communication network 500 maintains a good reputation and earns the trust of their customers.

The wireless communication system circuitry described above comprises computer hardware and software that form special-purpose data communication circuitry to characterize unauthorized use of wireless network slices. The computer hardware comprises processing circuitry like CPUs, DSPs, GPUs, transceivers, bus circuitry, and memory. To form these computer hardware structures, semiconductors like silicon or germanium are positively and negatively doped to form transistors. The doping comprises ions like boron or phosphorus that are embedded within the semiconductor material. The transistors and other electronic structures like capacitors and resistors are arranged and metallically connected within the semiconductor to form devices like logic circuitry and storage registers. The logic circuitry and storage registers are arranged to form larger structures like control units, logic units, and Random-Access Memory (RAM). In turn, the control units, logic units, and RAM are metallically connected to form CPUs, DSPs, GPUs, transceivers, bus circuitry, and memory.

In the computer hardware, the control units drive data between the RAM and the logic units, and the logic units operate on the data. The control units also drive interactions with external memory like flash drives, disk drives, and the like. The computer hardware executes machine-level software to control and move data by driving machine-level inputs like voltages and currents to the control units, logic units, and RAM. The machine-level software is typically compiled from higher-level software programs. The higher-level software programs comprise operating systems, utilities, user applications, and the like. Both the higher-level software programs and their compiled machine-level software are stored in memory and retrieved for compilation and execution. On power-up, the computer hardware automatically executes physically-embedded machine-level software that drives the compilation and execution of the other computer software components which then assert control. Due to this automated execution, the presence of the higher-level software in memory physically changes the structure of the computer hardware machines into special-purpose data communication circuitry system to characterize unauthorized use of wireless network slices.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. Thus, the invention is not limited to the specific embodiments described above, but only by the following claims and their equivalents.

What is claimed is:

1. A method, the method comprising:
receiving requests from wireless communication devices to use a wireless network slice;
determining that the use of the wireless network slice by the wireless communication devices would be unauthorized, and in response, serving the wireless communication devices using the wireless network slice; and
identifying a characteristic of the wireless network slice responsive to serving the wireless communication devices using the wireless network slice.

2. The method of claim 1 further comprising:
wirelessly broadcasting slice information related to the wireless network slice; and
wherein the wireless communication devices request the wireless network slice responsive to the wireless broadcast.

3. The method of claim 1 further comprising:
wirelessly broadcasting slice information related to a high-throughput service provided by the wireless network slice; and
wherein the wireless communication devices request the wireless network slice responsive to the slice information.

4. The method of claim 1 further comprising:
wirelessly broadcasting slice information related to a low-latency service provided by the wireless network slice; and
wherein the wireless communication devices request the wireless network slice responsive to the slice information.

5. The method of claim 1 further comprising:
wirelessly broadcasting slice information related to a high-definition service provided by the wireless network slice; and
wherein the wireless communication devices request the wireless network slice responsive to the slice information.

6. The method of claim 1 further comprising:
wirelessly broadcasting slice information related to a gaming service provided by the wireless network slice; and
wherein the wireless communication devices request the wireless network slice responsive to the slice information.

7. The method of claim 1 further comprising:
wirelessly broadcasting slice information related to a telepresence service provided by the wireless network slice; and
wherein the wireless communication devices request the wireless network slice responsive to the slice information.

8. The method of claim 1 wherein identifying the characteristic of the wireless network slice comprises identifying one or more types of the wireless communication devices.

9. The method of claim 1 wherein identifying the characteristic of the wireless network slice comprises identifying one or more user applications in the wireless communication devices.

10. The method of claim 1 wherein identifying the characteristic of the wireless network slice comprises identifying one or more operating systems in the wireless communication devices.

11. The method of claim 1 wherein identifying the characteristic of the wireless network slice comprises identifying one or more destination network addresses used by the wireless communication devices.

12. The method of claim 1 wherein identifying the characteristic of the wireless network slice comprises identifying one or more uniform resource indicators used by the wireless communication devices.

13. The method of claim 1 wherein identifying the characteristic of the wireless network slice comprises identifying one or more geographic locations of the wireless communication devices.

14. The method of claim 1 wherein no other wireless communication devices are authorized to use the wireless network slice.

15. A method, the method comprising:
wirelessly broadcasting slice information related to a wireless network slice and receiving requests from wireless communication devices to use the wireless network slice, wherein the wireless communication devices request the wireless network slice responsive to the wireless broadcast;
determining that the use of the wireless network slice by the wireless communication devices would be unauthorized, and in response, serving the wireless communication devices using the wireless network slice; and
identifying a characteristic of the wireless network slice responsive to serving the wireless communication devices using the wireless network slice, wherein the characteristic of the wireless network slice comprises at least one of: types of the wireless communication devices, user applications in the wireless communication devices, operating systems in the wireless communication devices, destination network addresses used by the wireless communication devices, uniform resource indicators used by the wireless communication devices, and geographic locations of the wireless communication devices.

16. A data communication system comprising:
control circuitry to determine that the use of a wireless network slice by wireless communication devices would be unauthorized, and in response, to direct communication circuitry to serve the wireless communication devices using the wireless network slice;
communication circuitry to serve the wireless communication devices using the wireless network slice responsive to the control circuitry; and
the control circuitry to identify a characteristic of the wireless network slice based on the service of the wireless communication devices using the wireless network slice.

17. The data communication system of claim 16 further comprising:
wirelessly broadcasting slice information related to the wireless network slice; and
wherein the wireless communication devices request the wireless network slice responsive to the wireless broadcast.

18. The data communication system of claim 16 wherein identifying the characteristic of the wireless network slice comprises identifying one or more types of the wireless communication devices.

19. The data communication system of claim 16 wherein identifying the characteristic of the wireless network slice comprises identifying one or more user applications in the wireless communication devices.

20. The data communication system of claim 16 wherein no other wireless communication devices are authorized to use the wireless network slice.
